(19) United States
(12) Patent Application Publication
(10) Pub. No.: US 2014/0206378 A1
(43) Pub. Date: Jul. 24, 2014

(54) SYSTEM FOR IDENTIFYING PROXIMITY OF MOBILE DEVICES

(71) Applicant: Domenica Nadjeschda Engelbrecht, Burgeln (CH)

(72) Inventor: Domenica Nadjeschda Engelbrecht, Burgeln (CH)

(21) Appl. No.: 13/745,823

(22) Filed: Jan. 20, 2013

(51) Int. Cl. H04W 4/02

(52) U.S. Cl. CPC H04W 4/025
USPC 455/456.1

(57) ABSTRACT

Disclosed is a method of testing the proximity of two or more mobile devices by means of a multiple choice test based on sensory signals. A sensory signal is emitted by one ore more emitting device. If a user in a multiple choice test which is presented on an identifying device correctly chooses the emitted signal out of a list of possibly emitted signals the emitting device(s) and the identifying are considered to be in close contact.

### BACKGROUND OF THE INVENTION

1. Field of Invention

Present invention in general relates to various methods of identification and in particular relates to the identification of computing devices in a proximate area so that communication can be established amongst multiple computing devices within the proximate area.

2. Description of Related Art

Proximate identification methods have long evolved from determination of distance between two computing devices using GPS system using a verification method with a code to determine longitude and latitude of a computing device with comparison to another computing device. However, methods using GPS locating systems are unreliable and are nearly unusable inside buildings because the roof blocks the contact with the GPS satellite. Other locating methods than GPS are not yet available in all locations. GPS and other locating methods will usually not take account of internal building structure and consider players to be in close contact even if those players are separated by a floor or a wall.

Another method of proximity determination is the use of a peer-to-peer communication between devices where the inbuilt sensors of one device detect the signal from the other device.

So far developed methods of proximate distance determination are dependent on the make and age of the participating computing device because the sensory detection capabilities of individual devices can vary strongly with such factors. In a game a device with good detection capabilities can give the owners of such devices an unfair advantage over the owners with devices that have no or inferior sensory detection capabilities.

Thus, there is a need for a proximate determination method, or enabling system or apparatus, which is independent of the limitations as discussed above and which will enable a more accurate and error free verification of two or more devices being in close contact with each other.

The present invention addresses innovations in proximate identification methods by enabling users of computing devices to interact with others with ease without dependency on various limitations as described above.

### SUMMARY OF THE INVENTION

In accordance with the teachings of the present invention, a system for identifying proximity of user operated mobile devices, is provided.

An objective of the present invention is to provide a system including an emitting device and an identifying device to identify the emitting device, once the emitting device is in close range.

Another objective of the present invention is to provide the emitting device with a unique device identity, further the emitting device when it emits one or more signals, creates a time stamp of the emission and keeps a record of the one or more signals. This information is then used to create as unique emission event identifier which is received by the identifying device. The identification device analyses the time stamps of the unique emission event identifier and further creates a multiple choice test and identifies the emitting device on the basis of the answer choice provided by the emitting device.

Another objective of the present invention is to provide a system with a server. The server triggers one or more signals for the emitting device and further transfers unique emission event identifiers between said emitting devices and said identification device to facilitate creation of the multiple choice test and identification of emitting device.

Another objective of the system is to punish the user for choosing a wrong answer choice so as to prevent him from guessing answers.

Another objective of the system is to provide the system with a reference data table to provide a list of playable signal files associated with their signal identifiers and further the system will include one or more output devices to play the signals contained in said reference data table when they are triggered.

### BRIEF DESCRIPTION OF DRAWINGS

FIG. 1 illustrates the network architecture of a system 100, in accordance with a preferred embodiment of the present invention;

FIG. 2 illustrates a block diagram of plurality of emitting devices in a system 200, in accordance with a preferred embodiment of the present invention;

FIG. 3 illustrates a schematic diagram of five signals present in an identification device, in accordance with a preferred embodiment of the present invention;

FIG. 4 illustrates a schematic diagram of a system with a server for identification of operated proximate devices; and

FIG. 5 illustrates a table to represent a reference data table.

### DETAILED DESCRIPTION OF DRAWINGS

While this technology is illustrated and described in a preferred embodiment, system for identifying the proximity of user operated mobile devices may be produced in many different configurations, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

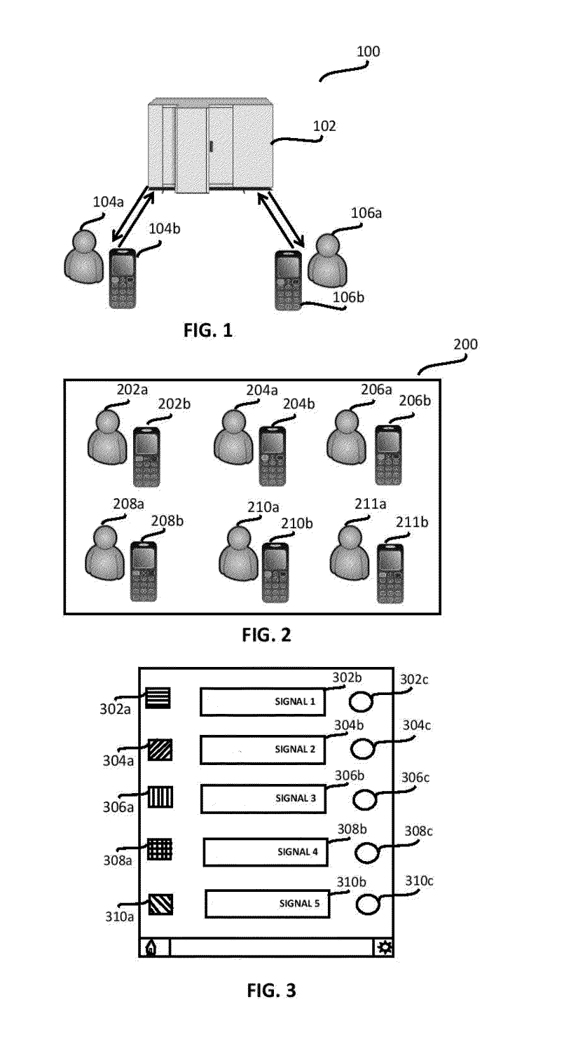

Referring to FIG. 1, this drawing illustrates the network architecture of a system 100, in accordance with a preferred embodiment of the present invention. The system 100 includes an emitting device 104b and an identifying device 106b. The emitting device 104b and the identifying device 106b are operated by a user 104a and a user 106a, respectively. The emitting device 104b includes a device identity which is unique to it. The identifying device 106b as well includes a device identify which is unique to it.

The emitting device 104b emits one or more signals, creates a time stamp associated with each signal emitted and keeps a record of the one or more signals emitted. Further, each event of emitting the signal is recorded together with the time stamp of the event, the device identity of the emitting device 104b and the identifier of the signal to create a unique emission event identifier. The identifying device 106b receives the unique emission event identifiers. Further, the identifying device 106b analyses the time stamps of the one or more unique emission event identifiers received to select at least one of the one or more unique emission event identifiers that corresponds to a certain predetermined time frame.

Furthermore, the identifying device 106b utilizes the selected unique emission event identifier to create a multiple choice test consisting of the signals emitted by the emitting device 104b. In a preferred embodiment this multiple choice test in addition contains other signals as distractors. Thereafter, the identifying device 106b identifies the emitting device 104b if the identifying device 106b chooses the answer choice provided by the emitting device 104b.

In a preferred embodiment of the present invention, the emitting device 104b will provide preferably one answer choice to the multiple choice test through the unique emission event identifier. The user 106a will choose one answer choice from the multiple choice test on the identifying device 106b. If the chosen answer choice is the same as provided by the identifying device 104b, then the user 106a has identified the emitting device 104b and the user 106a is informed about the successful identification. The user may further be awarded game credits for the successful identification.

The unique emission event identifier provides information about the signal that was emitted, the device that emitted it and the time of emission by the emitting device 104b to the identification device 106b. In an exemplary embodiment, the unique emission event identifier is Monday20:32h/Device1023/Melody3. Here, first part (Monday20:32h) contains the time stamp, the second part (Device1023) contains device identity and third part (Melody3) contains the signal identifier of the signal that was emitted. It might be further within the scope of this invention that the unique emission event identifier contains a forth part in which the actual signal, for example a video file or an audio file, is stored.

Examples of the one or more signals include, but are not limited to, audio signals, visual signals and audio-visual signals. Audio-visual signals can be provided in the form of a video, since videos can contain audio too. Possible signals that can be used are kind of sensory signals that may be detected and distinguished by human senses. The one or more signals are explained in detail in conjunction with FIG. 3 of the present invention.

Examples of multiple choice tests include, but are not limited to, choosing one melody from plurality of melodies. The multiple choice test is explained in detailed in conjunction with FIG. 3 of the present invention.

In another preferred embodiment of the present invention, the system 100 further includes a server 102. The server 102 triggers the one or more signals for the emitting device 104b. While doing so the server may control that in a certain time frame only a maximum number of signals are triggered, and not more. The server 102 then transfers unique emission event identifiers between the emitting device 104b and the identification device 106b to facilitate the creation of the multiple choice test on the device 60b and the identification of the emitting device 104b by the identification device 106b. In yet another embodiment of the present invention, the server 102 sends the entire multiple choice test to the identification device 106b to identify the emitting device 104b, if the identification device 106b chooses the answer choice provided by the emitting device 104b.

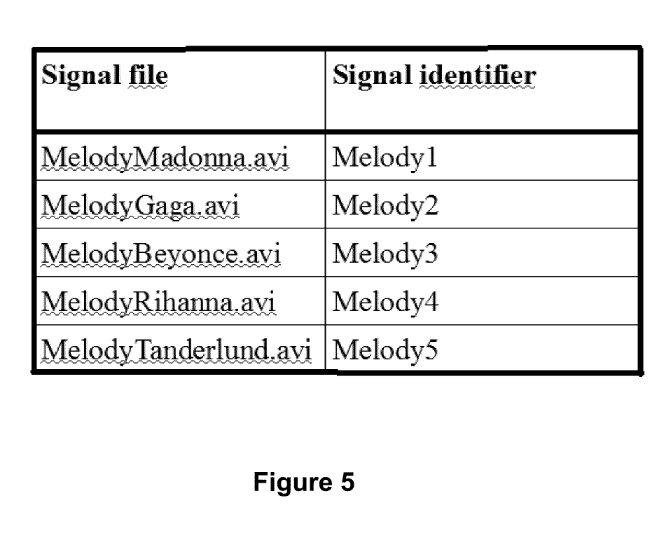

The server 102 may further include a reference data table to provide a list of actual signals associated with signal identifiers as a file to be played on the emitting device 104b. In another embodiment of the present invention, the reference data table may further be stored in other computing devices preferably all identifying devices and all emitting devices. This may make the triggering of signals easier. Examples of such other computing devices include but are not limited to mobile phones, iPad, Notebook etc. An Example of a reference table is explained in detail in conjunction with FIG. 5 of the present invention.

In yet another embodiment of the present invention, the system 100 may further include one or more output devices to play signals contained in the reference data table. Also, the output devices may also be a output devices of the identification device 106b and the emitting device 104b. Examples of such output devices include, but are not limited to, speakers, LED, flashlight and speakers and screen of the devices.

FIG. 2 illustrates a block diagram of a plurality of emitting devices in a system 200, in accordance to a preferred embodiment of the present invention. The system 200 includes a plurality of emitting devices such as 202b, 204b, 206b, 208b and 210b. Further the system 200 includes an identification device 211b. The emitting devices 202b, 204b, 206b, 208b and 210b will create and sends five unique emission event identifiers to the identification device 211b. The identification device 211b analyses the received unique emission event identifiers and then creates the multiple choice test based on this analysis. The emitting devices 202b, 204b, 206b, 208b and 210b provide one answer choice each for the multiple choice test through means of the unique emission event identifiers.

The identifying device 211b chooses one answer choice out of the possible answer choices and further identifies the right emitting device out of emitting devices 202b, 204b, 206b, 208b and 210b which was associated with said answer choice. It is within the scope of the invention that the device 211b keeps a record of all received unique emission event identifiers received, so as to use them for the building of other multiple choice test. In another embodiment the identifying device will only consider those unique emission event identifiers that are send by one particular device or a particular group of devices and ignore the rest.

In an exemplary embodiment of system 200, emitting device 202b and 204b provide a unique emission event identifier which has a time stamp which corresponds to a defined time frame (e.g. a maximum of 3 minutes in the past counted from the initializing of the test) that the multiple choice test is considered to refer too. Further, in that example emitting devices 206b, 208b and 210b do not provide the corresponding time stamps needed because the time stamps in the unique emission event identifier they provide are older than three minutes or because they have not emitted any signal in that time frame and hence have not provided any unique emission event identifiers that correspondent to that time frame.

Upon analysing the situation, the identification device 211b ignores the unique emission event identifiers of the emitting devices 206b, 208b and 210b, that those may have provided. The identification device 211b creates the multiple choice test to enable the identification of the emitting devices 202b and 204b. For an exemplary embodiment, out of the emitting devices 202b and 204b, the emitting device 202b provides the one right answer choice inside the multiple choice test and thus the emitting device 202b is identified by the identification device 211b if that answer choice is chosen by the user 211a of identification device 211b. In yet another embodiment of the present invention, the emitting device 204b has also provided one right answer choice but only one choice can be chosen per test. Hence, the emitting device 204b is not identified.

In yet another embodiment of the present invention, system 200 may be connected to a server (not shown in FIG. 2). The server 102 (not shown in FIG. 2) will receive the unique event emission identifier from the emitting devices 202b, 204b, 206b, 208b and 210b and keeps a record of it. The identification device 211b requests the server (not shown in FIG. 2) to create a multiple choice test for a defined time frame (for the last 3 minutes or for between 20 and 30 minutes ago). On receiving the request the server (not shown in FIG. 2) will forward only those unique emission event identifiers to the identification device 211b that corresponds to the selected time frame. For exemplary purpose, the emitting devices 202b and 204b have time stamps which are corresponding to that time frame.

The emitting devices 206b, 208b and 210b again have not provided unique emission event identifiers that correspondent to the required time frame. The identification device creates the multiple choice test on the basis of the forwarded unique emission event identifier by the server 102. The server (not shown in FIG. 2) is then informed when the user 211a chooses an answer choice that correspondence to either the emitting device 202b or 204b. Depending on which answer choice he has chosen he will have identified either device 202b or 204b. If the user 211a chooses an answer choice that correspondence neither to 202b or 204b the server may be informed about this failure of user 211b.

Referring to FIG. 3, illustrated is an embodiment 300 of five signals present in the identification devices, as per this invention. The invention describes a set of five signals 302b, 304b, 306b, 308b and 310b with each one of the five signals 302b, 304b, 306b, 308b and 310b being associated with a corresponding color 302a, 304a, 306a, 308a and 310a. Also, described are corresponding means 302c, 304c, 306c, 308c and 310c for selecting one of the five signals 302b, 304b, 306b, 308b and 310b. It would be within the scope of this invention that, a programmable application may be developed and used for training various players of a game to associate the correct color or correct melody with a signal or signal name or signal identifier that is used in the game. Further, as per another embodiment of the invention, the signals 302b, 304b, 306b, 308b and 310b are five distinct audios and the five corresponding colors 302a, 304a, 306a, 308a and 310a are five distinct visuals.

In yet another embodiment, the identification device may contain a text box for the user to enter the answer choice (for example the name of the signal) in the text box. In yet another embodiment of the invention, in a gaming environment (virtual or real time), the signals 302b, 304b, 306b, 308b and 310b are five distinct audios and the five corresponding colors 302a, 304a, 306a, 308a and 310a are five distinct visuals to be used for the identification of the proximate emitting devices.

If an identification device successfully identifies an emitting device by the described methods then both identification device and emitting device may be considered to have been in close proximity when the signal was emitted on the emitting device. The signal may not have been detected by the user of the identifying device if he may not have been in close proximity to the emitting device.

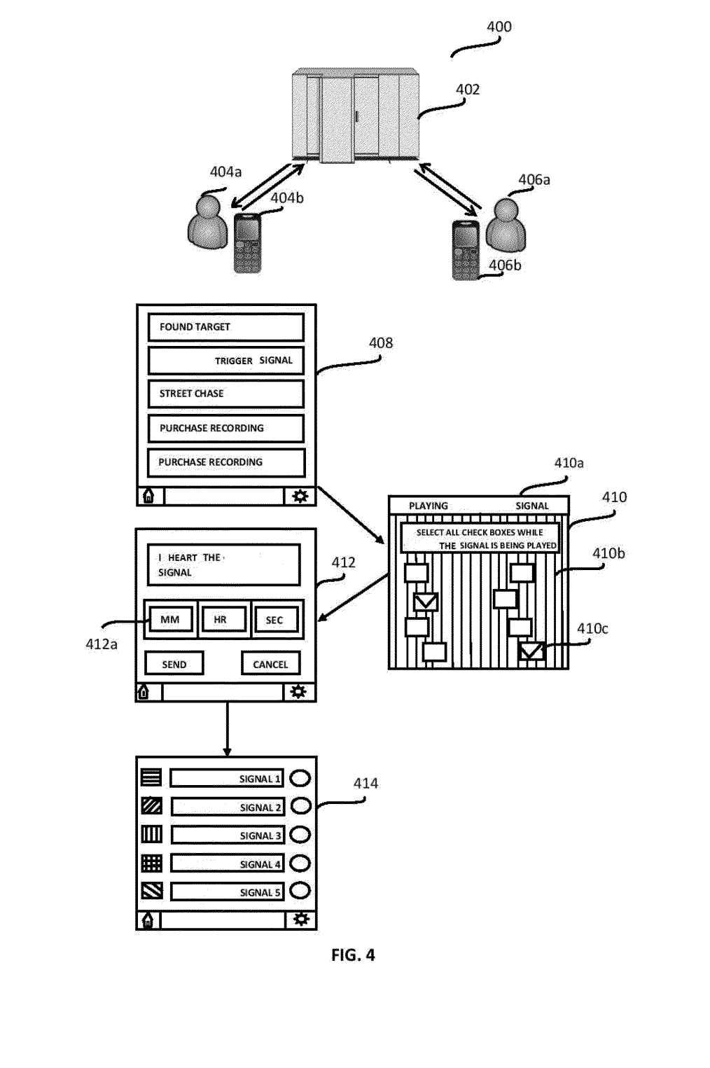

Referring to FIG. 4, illustrated is a system 400 with a server 402 for identification of a user 404a of an emitting device 404b and a user 406a of an identification device 406b. Both the devices 404b and 406b are capable of communicating with the server 402 and the server 402 is configured to send and receive requests from the devices 404b and 406b. The user 404a operates the emitting device 404b which has a set of five predefined signals. Similarly, the user 406a operates the device 406b which has the same set of predefined five signals. Further, the server 402 is configured to store the predefined five signals together with their signal identifiers, and the unique emission event identifier relating the emitting device 404b and the identification device 406b.

In the event, that the user 406a operating the identification device 406b, is in the vicinity or proximity of the user 404a operating emitting device 404b, the user 406a of device 406b can hear and/or see that one of the signals that have been played on the emitting device 404b. With reference to 408, the user 406a than uses the found target button to initiate the creation of the multiple choice test. With reference to 412, the user of the identifying device 406a is further allowed to select the time frame when the user 406a has heard and/or seen the signal. In this embodiment of the present invention, the identifying user 406a selects a certain point in time to which the multiple choice test will refer to and the device 406b will consider all unique emission event identifiers that have time stamps corresponding to times shortly before or after the selected point in time (for example maximally three minutes before and after the selected time, which will give a time frame of six minutes in total) for creating the multiple choice test.

In another embodiment, step 412 can be skipped in which case the time frame will be automatically selected to be some defined time shortly before the test is requested by user 406a. This can be counted for example from the moment the user 406a presses the “found target” button on the screen shown in 408. (for example time stamps will be considered that are not older than three minutes counting from this action). When the time frame to which the test refers to has been defined by the one or the other method of defining a time frame, the multiple choice test can start.

As described before, the 5 signals correspond to 5 distinct audio melodies, however the number of signals can be increased or decreased. In another embodiment of the present invention, the user 406a of the identifying device 406b may be punished if he selects a wrong option in the multiple choice test. A wrong option is a signal that has not been played on any emitting device 406b in the defined time frame. Such wrong options might be in the terminology of multiple choice test also being called distractors. Examples of the punishment may be in the form of subtracting game credits from the game credits account of the user 406a of the identifying device 406b.

It might be further in the scope of invention (not shown in Figures), to check if the audio part has been correctly emitted so that it may be detected by other players. This can be done by indirect checks such as checking that the sound level of the speakers is set to a certain minimum level of possible loudness of speakers or that no earplugs are plugged in. If earplugs are plugged in most devices now will output any possible audio signal through the earplugs and not through the in-build speakers of the device.

If the loudness level of the speakers is found to be not adequate and/or if earplugs are plugged in the user of emitting device 404b may be punished. Examples of punishment include, but not limited to, deducting game credits from his game credit account. It can also be done by a direct check which would consist of recording the emitted signal through for example using the in-build microphones of device 404b. This anti cheat measures will prevent the user 404a from hiding the audio part of the signal (or if the signal consists only of an audio file prevent user 404a from hiding the entire signal).

The multiple choice test will contain the possible signals and/or the name of the signals. The name of the signal can be the signal identifier, but it can as well be a name in plain everyday language such as the name of the song “like a prayer” (Madonna). If the signal is not playable directly from the multiple choice test itself, it can be accessed in a training section where all possible signals can be trained, and where they are listed together with their names.

Block 410 indicates the screen of the emitting device 404b while it is emitting a signal. The number 410b refers to the color of the signal which is spread generously over the screen. In the same moment this signal is displayed any audio part associated with the signal may be played too.

The 410c refers to an interactive element, in this case a check box. These check boxes must all be checked by user 404a within the time the signal itself is played. If the user 404a is not able to do so in time he might be punished by for example deducting game credits from his game credit account. This is a measure to prevent the user 404a from covering the screen of device 404b during the emission of the signal. It might be in the scope of this invention to implement other measures that require mandatory eye contact by user 404a to the screen of the device 404b and hence will prevent him from covering the screen. This is an anti-cheat measure that will prevent the user 404a from hiding the visual part of the emitted signal.

The block 414 indicates an exemplary embodiment of the multiple choice test.

FIG. 5 illustrates a table to represent a reference data table, in accordance with a preferred embodiment of the present invention. In every game a limited set of possible signals should be used. For example, there may be six melodies which are each available as a playable audio file or as a playable video file, if a colour is associated to each signal. The six video files may be stored in the form of a table where each video file is associated with an unique signal identifier. For example the song from Madonna could be associated with the signal identifier “Melody1”, the song from Lady Gaga could be associated with the signal identifier “Melody2”, the song from Beyonce could be associated with the signal identifier “Melody3” and so on.

This table should be available to all emitting devices and identifying devices that need to play the signals and hence need to know what signal to play (this includes the emitting and the identifying devices) and will be stored on a server too, if a server is used. The benefit of this table is that the signal files themselves (which are audio files and/or video files or images and which are hence quiet large) don't have to be send around every time a signal is played on an emitting device, or every time an identifying device starts the identification process or wants to train a signal. Instead the signals identifiers may be send and used to trigger the corresponding signal from the table to be played. It would however be in the scope of the invention to send around the signals as files together with the unique emission event identifier (as part of the unique emission event identifier).

The system offers various advantages. The system may be used to play a game of chase and hunt. In one example the players may be divided in two groups, players of one group—the hunters (the owners of the identifying devices) have to identify the devices of the other group—owned by the targets (the emitting devices owners). The targets have to hide and by this to escape the identification. In a preferred embodiment the server would coordinate which emitting devices would emit which signals at what time. The server can choose to emit only a defined maximum amount of signals in a certain time period, for example only 2 of 5 possible signals every 3 minutes.

In another example of the game, here each participant has to try to not get identified by other participants in the game. In this case, the identifying devices and emitting devices can be identical or switch roles, but no device can identify itself.

In yet another example of the game, one hunter has to identify a particular target. In this case he would only use those unique emission event identifier for creating the multiple choice test which he receives from that particular target.

The foregoing discussion discloses and describes merely exemplary embodiments of the present invention. One skilled in the art will readily recognize from such discussion and from the accompanying drawings that various changes, modifications and variations can be made therein without departing from the spirit and scope of the invention.

1. A system for identifying the proximity of user operated mobile devices, the system comprising:
an emitting device having a unique device identity, said emitting device emits one or more signals, creates a time stamp associated with each signal emitted, keeps a record of said one or more signals emitted, wherein each event of emitting a signal is recorded together with said time stamp of the event, said device identity and identifier of the signal to create one or more unique emission event identifiers; and
an identification device receiving said unique emission event identifiers, further analysing said time stamps of said one or more unique emission event identifiers to select at least one of the one or more unique emission event identifiers that corresponds to a certain predetermined time frame, further utilizing the selected unique emission event identifier to create a multiple choice test containing the signal from said emitting device.
wherein said emitting device provides at least one of the answer choices to said multiple choice test, further said identifying device identifies said emitting device if said identifying device chooses the answer choice provided by said emitting device.

2. The system according to claim 1 further comprising a server, wherein said server trigger said one or more signals for said emitting device, further said server transfers unique emission event identifiers between said emitting devices and said identification device to facilitate the creation of said multiple choice test and identification of said emitting device by said identification device.

3. The system according to claim 1 is a game, wherein if a wrong answer is provided then the user of emitting device may be punished.

4. The system according to claim 1 wherein the one or more signals may comprise either individually, or in combination of, an audio signal, a visual signal or an audio-visual signal.

5. The system according to claim 2 wherein said server further comprising a reference data table to provide a list of actual signals as files associated with their signal identifiers.

6. The system according to claim 5 wherein said reference data table may further be stored in other participating computing devices.

7. The system according to claim 1 comprising one or more output devices to play signals contained in said reference data table.

8. The system according to claim 1 wherein said server triggers said one or more signals for said emitting device, further said server facilitates the creation of said multiple choice test so as to enable the identification of said emitting device by said identification device trough said multiple choice test if a user of the identification device chooses the right answer choice in said multiple choice test.

9. The system according to claim 2, wherein a plurality of emitting devices in the predetermined time frame emits one or more signals, said server facilitates the creation of the multiple choice test referring to said predetermined time frame on said identification device such that one or more of the answer choices in the multiple choice test represents the one or more signals emitted and the emitting devices on which that signals have been emitted.

10. The system according to claim 1 wherein if said answer choice is chosen it is analyzed by said identification device, to find out to which of the plurality of said emitting devices said answer choice is corresponding to and said emitting devices which it is corresponding to is identified by said identification device and further said server receives the information about identification of said emitting device by said identification device.

11. The system according to claim 1 wherein said emitting device produces either a video signal, audio signal, audio-video signal, or visual signal wherein each of said signals contains a unique signal identifier which will be included in any of said unique event emission identifier produced.

12. The system of claim 1 wherein said emitting device identifies any of said plurality of emitting devices.

13. The system according to claim 1 wherein said emitting device comprising anti-cheat measures to ensure said emitted signal will not be purposefully hidden by the user of said emitting device.

14. The system according to claim 1 wherein the multiple choice test contains distractors, said distractors are the wrong answer choices that do not correspond to any emitted signal considered for said multiple choice test.

15. The system of claim 1 wherein one or more unique emission event identifiers comprising said time stamp, said device Identifier, said signal identifier and said signal as a file.

16. The system according to claim 2, wherein said server controls and limits the number of signal emitted in said predetermined time frame.

17. A system for identifying proximity of user operated mobile devices, the system comprising:
a server to trigger one or more signals;
an emitting device having a unique device identity, said emitting device emits one or more signals, creates a time stamp associated with each signal emitted, keeps a record of said one or more signals emitted, wherein each event of emitting a signal is recorded together with said time stamp of the event, said device identity and identifier of the signal to create one or more unique emission event identifiers; and
an identification device to identify said emitting device;
wherein said server receives said unique emission event identifiers, further said server analyses said time stamps of said one or more unique emission event identifiers to select at least one of the one or more unique emission event identifiers that corresponds to a certain predetermined time frame;
wherein said server transfers said unique emission event identifiers between said emitting device and said identification device to facilitate the creation of the multiple choice test, wherein said identification device utilizes the unique emission event identifier selected by the server to create a multiple choice test containing the signal from said emitting device;
wherein said emitting device provides one of the answer choices to said multiple choice test, further said identifying device identifies said emitting device if said identifying device chooses the answer choice provided by said emitting device.

18. The system according to claim 17 wherein the one or more signals may comprise either individually or in combination of an audio signal, visual signal or an audio-visual signal.

19. The system according to claim 17 wherein said server further comprising a reference data table to provide a list of actual signals as files associated with their signal identifiers.

20. The system according to claim 17 wherein said reference data table may further be stored in other participating computing devices.

21. The system according to claim 17 wherein said server trigger said one or more signals for said emitting device, further said server facilitates the creation of said multiple choice test so as to enable the identification of said emitting device by said identification device trough said multiple choice test if a user of the identification device chooses the right answer option in said multiple choice test.

22. The system according to claim 17, wherein a plurality of emitting devices in the predetermined time frame emits one or more signals, said server facilitates the creation of the multiple choice test referring to said predetermined time frame on said identification device such that one or more of the answer choices in the multiple choice test represents the one or more of the signals emitted and the emitting devices on which that signals have been emitted.

23. The system according to claim 17 wherein if said answer choice is chosen it is analyzed by said identification device, to find out to which of the plurality of said emitting devices said answer choice is corresponding to and said emitting device is identified by said identification device and further said server receives information about identification of said emitting device by said identification device.

24. The system according to claim 17 wherein said emitting device produces either a video signal, audio signal, audio-video signal or visual signal, wherein each of said signals contains a unique signal identifier which will be included in any of said unique event emission identifier produced.

25. The system according to claim 17 is a game, wherein if a wrong answer is provided then the user of emitting device may be punished.

26. The system according to claim 17 wherein said emitting device identifies any of said plurality of emitting devices.

27. The system according to claim 17 wherein said emitting device comprising anti-cheat measures to ensure said emitted signal will not be purposefully hidden by the user of said emitting device.

28. The system according to claim 17 wherein the multiple choice test contains distracters, said distracters are the wrong answer choices that do not correspond to any emitted signal considered for said multiple choice test.

29. The system of claim 17 wherein one or more unique emission event identifiers comprising said time stamp, said device Identifier, said signal identifier and said signal as a file.

30. The system according to claim 17, wherein said server controls and limits the number of signal emitted in said predetermined time frame.
